(19) United States
(12) Patent Application Publication
(10) Pub. No.: US 2020/0339266 A1
(43) Pub. Date: Oct. 29, 2020

(54) SYSTEM AND METHOD FOR AIRCRAFT SEAT AND SUITE CONTROL VIA A PERSONAL ELECTRONIC DEVICE

(71) Applicant: Crane Co., Stamford, CT (US)

(72) Inventor: Scott McMillan, Woodland Hills, CA (US)

(21) Appl. No.: 16/536,110

(22) Filed: Aug. 8, 2019

Related U.S. Application Data
(60) Provisional application No. 62/838,816, filed on Apr. 25, 2019.

(51) Int. Cl. B64D 11/06; H04W 76/10; H04B 17/318; H04W 4/80

(52) U.S. Cl. CPC B64D 11/0624; H04W 76/10; H04W 76/30; H04W 4/80; B64D 11/0639; H04B 17/318

(57) ABSTRACT

A system and method for controlling a seat device. A control unit broadcasts an identifier associated with a seat assigned to a passenger, and establishes a personal wireless area network connection with a personal electronic device (PED) associated with the passenger. The control unit monitors strength of a signal received from the PED over the wireless personal area network, and sets a flag based on the strength of the signal. The control unit receives, over the wireless personal area network, a command from the PED to control the seat device, and determines state of the flag in response to the command. The control unit transmits a signal to take an action invoked by the command in response to the flag being in a first state, and refrains from transmitting the signal to take the action invoked by the command in response to the flag being in a second state.

### CROSS-REFERENCE TO RELATED APPLICATION

This application claims the benefit of U.S. Provisional Application No. 62/838,816, filed Apr. 25, 2019, the content of which is incorporated herein by reference.

### FIELD

Aspects of the invention generally relate to seat actuation systems, and more particularly, to seat and suite control in an aircraft using a passenger's personal electronic device.

### BACKGROUND

Modern airplane seats, and in particular, seats in the premium sections of a passenger airplane are powered and adjustable between a number of seating positions. Some seats may be adjustable from an upright position to a reclined position, while others can recline to a substantially flat position in order to function as a bed. Additionally, some airplane seats have a head rest and a foot rest that can be adjusted to provide a comfortable seating position. The various adjustable features of the seat are accessible and controllable with a passenger control device unit which may include, for example, a keypad, touchscreen, buttons, and/or switches. The passenger control device may also provide the passenger with the ability to adjust the environmental conditions in the suite surrounding the seat, such as lighting, temperature, and the like. Furthermore, the passenger control device can allow the passenger to operate various entertainment devices and features associated with the seat, such as a display screen, for viewing movies.

Generally, the passenger control device for controlling the seat is preset and attached to or near the seat to be controlled. However the control of seats and other aspects of the passenger suite via the passenger control device or other traditional mechanisms may be awkward and cumbersome, often requiring the actuation of switches, buttons, and the like, which may be dispersed in various locations on, or near, the aircraft seat. For example, once a passenger has fully reclined a seat into the bed position, it can become difficult to reach many of the controls to return the seat to an upright position. It is very common for the seat maker to place an additional control in order to return the seat to the upright position, but depending on the placement, reaching such an additional control button might be difficult for some passengers. As another example, traditional control mechanisms may also be unsuitable for passengers with mobility issues.

Although some aircrafts today provide wireless tablets that are usually located in the seat-backs or tucked away in the armrests to allow control of some aspects of the aircraft, such aspects are often confined to in-flight entertainment (IFE). Expanding use of such tablets for seat control may be undesirable because the IFE system is generally not a trusted computing resource on the aircraft, and hence, raise certification issues when they are to be used to control seat actuation motion. In addition, wireless tablets used for IFE are generally only available in a small percentage of all aircraft seats (e.g. only in super first class seats). Thus, seat actuation control via the IFE is generally undesirable.

With the rise of personal electronic devices (PEDs) taking a more and more important role in many people's lives, for not only communication purposes, but for control and management of various aspects of a person's life, it is desirable to extend the use of a PED for aircraft seat and suite control when a passenger is on-board an aircraft. There are, however, numerous technical and certification challenges associated with this task. Accordingly, what is desired is a system and method that allows seat and suite control via a PED that satisfies various technical and certification challenges.

The above information disclosed in this Background section is only for enhancement of understanding of the background of the invention, and therefore it may contain information that does not form the prior art that is already known to a person of ordinary skill in the art.

### SUMMARY

According to one embodiment, a system and method is provided for controlling a seat device. A control unit broadcasts an identifier associated with a seat assigned to a passenger, and establishes a personal wireless area network connection with a personal electronic device (PED) associated with the passenger. The connection is established in response to the PED receiving the identifier and determining that the identifier is for the seat assigned to the passenger. The control unit monitors strength of a signal received from the PED over the wireless personal area network, and sets a flag based on the strength of the signal. The control unit receives, over the wireless personal area network, a command from the PED to control the seat device, and determines state of the flag in response to the command. The control unit transmits a signal to take an action invoked by the command in response to the flag being in a first state, and refrains from transmitting the signal to take the action invoked by the command in response to the flag being in a second state.

According to one embodiment, the control unit is configured to control seat devices associated with a plurality of seats, where the plurality of seats include the seat assigned to the passenger. The control unit transmits a unique identifier for each of the plurality of seats. The identifier may be a seat identifier.

According to one embodiment, the PED further hosts an application storing information on the seat assigned to the passenger. The application compares the received identifier with the information on the seat assigned to the passenger.

According to one embodiment, the personal wireless area connection is a Bluetooth Low Energy connection.

According to one embodiment, a system controller coupled to the control unit monitors a criteria. The system controller transmits a signal for enabling the communication over the wireless personal area network in response to detecting a first criteria, and transmits a signal for disabling the communication over the wireless personal area network in response to detecting a second criteria.

According to one embodiment, the command from the PED is an encrypted command that is decrypted by the control unit prior to taking the action invoked by the command.

According to one embodiment, the setting of the flag includes setting the flag to the first state in response to the strength of the signal being above a threshold value, and setting the flag to the second state in response to the strength of the signal being below the threshold value. The first state may be indicative of the passenger being in a line of sight to the seat assigned to the passenger, and the second state may be indicative of the passenger being out of the line of sight to the seat.

According to one embodiment, the control unit monitors an entrapment condition, and transmits a signal to stop the action invoked by the command in response to determining the entrapment condition.

According to one embodiment, the seat device is a component of the seat or a component of a suite surrounding the seat.

According to one embodiment, the control unit transmits, in response to the flag being in the second state, a message to the PED for indicating that the command is unavailable.

As a person of skill in the art will appreciate, embodiments of the present invention provide an efficient solution for suite control that does not rely on traditional buttons, switches or the like. By using the passenger's own personal electronic device for suite control, control of the passenger's seat and related components may be at a user's fingertip at all times. All passengers owning a PED, including passengers with mobility issues, may thus easily control their assigned seats and associated components.

However, allowing suite control via a PED does not mean that passengers may control the seats at any time and any place. Doing so may pose danger to those around the seat. Thus, embodiments of the present invention has safeguards in place to ensure that safety regulations are complied with to prevent harm to passengers. For example, safeguards are put in place so that control of a seat via a PED is by the passenger assigned to the seat, and that control is allowed when the passenger is deemed to be within a particular distance from the seat.

### BRIEF DESCRIPTION OF THE DRAWINGS

The accompanying drawings, together with the specification, illustrate example embodiments of the invention, and, together with the description, serve to explain the principles of the invention.

FIG. 1 is schematic diagram of an aircraft passenger seat and control system according to one exemplary embodiment;

FIG. 2 is a schematic block diagram of a seat of FIG. 1 according to an exemplary embodiment;

FIG. 3 is a more detailed block diagram of control unit for controlling seats according to one exemplary embodiment;

FIG. 4 is a flow diagram of a process for establishing a wireless personal area network connection between a control unit and a particular personal electronic device according to an exemplary embodiment;

FIG. 5 is a flow diagram of a process for controlling a seat device based on commands from a personal electronic device according to an exemplary embodiment; and

FIGS. 6A-6B are screen shots of a graphical user interface (GUI) provided by an application hosted in a personal electronic device for controlling seat devices according to an exemplary embodiment.

### DETAILED DESCRIPTION

In the following detailed description, only certain exemplary embodiments of the invention are shown and described, by way of illustration. As those skilled in the art would recognize, the invention may be embodied in many different forms and should not be construed as being limited to the embodiments set forth herein. Descriptions of features or aspects within each exemplary embodiment should typically be considered as available for other similar features or aspects in other exemplary embodiments. Like reference numerals designate like elements throughout the specification.

In one embodiment, a system and method for seat control is provided that allows a passenger to use his personal PED (e.g. smartphone, tablet, laptop computer, or the like), to control a seat assigned to him by an airline. In one embodiment, the PED is enabled for Bluetooth Low Energy (Bluetooth LE) that allows for communication via radio frequency (RF) waves. Of course, a person of skill in the art should recognize that other wireless communication mechanisms may also be used in lieu or in addition to Bluetooth LE.

In one embodiment, each seat (via its control unit) advertises a unique identifier based on its LOPA (layout of passenger accommodation) position. The LOPA position is, in most occasions, the seat identifier/number. The adverting of the LOPA position by each seat allows the PED to make a wireless communication connection to the control unit of the seat assigned to the passenger. In this regard, an application provided by the airline and running on the PED includes the assigned LOPA position (seat ID) of the passenger for the current flight. Because the application contains the passenger's LOPA information, the application automatically looks for and connects to the correct control unit when the passenger is in close proximity to the correct control unit. The connection that is made based on the seat identifier/number helps to ensure that only the passenger that is assigned to the seat can operate the seat, helping meet certain safety requirements that may be necessary for the seat to be certified as safe. Once connected, the application may then start sending seat/suite control commands via the wireless communication connection.

In one embodiment, the strength of the emissions from the PED is monitored to ensure that the seat/suite can only be operated via the PED when in close proximity to the seat. This also helps comply with certain safety requirements that may need to be met in order for the seat to be certified as safe. In addition, regulations related to electromagnetic interference (EMI) may be complied with by ensuring that the capability for wireless communication between the control unit and the PED is not enabled until an express signal is transmitted by a system controller. An embodiment of the invention also complies with other safety requirements that may need to be satisfied in order for the seat to receive an appropriate certification.

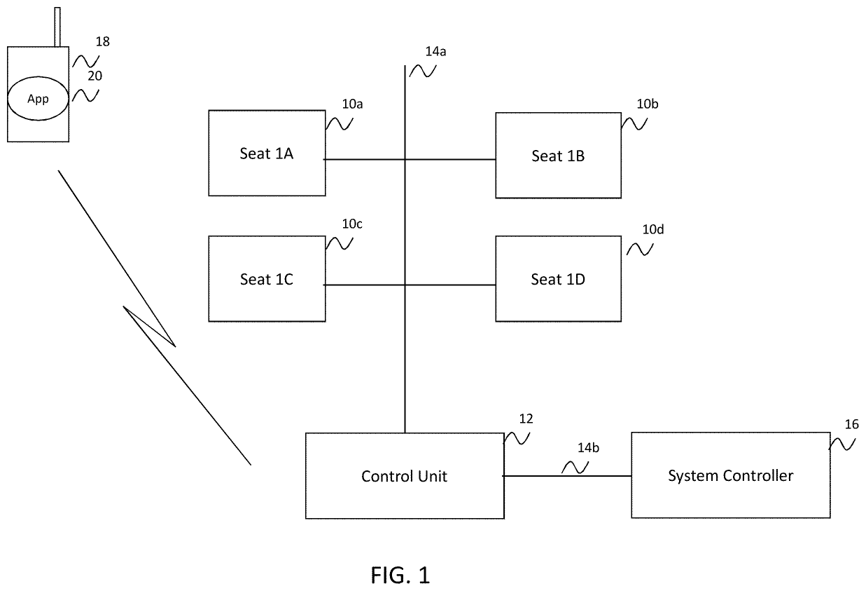

FIG. 1 is a block diagram of a system for controlling a seat component associated with an aircraft seat according to an exemplary embodiment. The system includes one or more seats 10a-10d (collectively 10) coupled to a control unit 12 over a data communication bus 14a. In one embodiment, multiple control units 12 are provided within the aircraft for controlling the various seats in the aircraft. According to one embodiment, the multiple control units 12 interface with a central system controller 16 over a data communication bus 14b. The central system controller may include a processor, memory, and wired/wireless communication interface for communicating with the various control units 12.

The data communication bus 14a, 14b (collectively 14) may be a serial digital communication bus that uses, for example, a Controller Area Network (CAN) standard. However, communication between the control unit 12 and the seats 10, and between the control unit 12 and the system controller 16, may be conducted based on one of various communications mechanisms such as “Ethernet”, RS-485, infrared, or radio frequency communications.

Each of the seats 10 is located in certain location of the aircraft cabin. A portion of the cabin surrounding a passenger's seat may be referred to as the passenger's suite. Each seat may be associated with certain devices also located on the seat or in the suite, such as, for example, seat warmers, cabin lights, furniture lights, audio components, IFE system, air vent, and/or the like (collectively referred to as a seat device).

Each seat 10 is assigned a unique identifier associated with the seat's LOPA position (referred to herein as the seat ID). The seat ID may correspond to the seat number/letter combination that is used by the airlines to assign seats to passengers. In one embodiment, each control unit 12 is programmed with the seat ID(s) of the seat(s) 10 that it controls. The seat ID may also be configured in other seat devices such as, for example, an-flight entertainment system.

In one embodiment, an authorized passenger in an aircraft may control a seat device associated with his seat 10 using his PED 18. The PED may be the passenger's personal smartphone, smart watch, tablet, laptop computer, and/or any portable device conventional in the art. In one embodiment, the PED 18 is equipped with a processor, memory, and other hardware and software for transmitting wireless commands to the control unit 12 to operate the seat device within the aircraft. In this regard, the PED 18 hosts an application 20 that is provided by an airline of the aircraft. The application 20 may be a stand-alone application that is downloaded to the PED, and/or web application accessed via a web browser hosted by the PED 18. The application 20 may be invoked by a user to book new flights of the airline, and manage existing flights. The application 20 may also be invoked by the passenger to control his seat/suite once onboard a booked flight. In one embodiment, in order to comply with certain safety regulations, control of the seat devices via the PED 18 is only allowed via the application 20 that is provided by the airline.

In one embodiment, the control unit 12 is configured with a processor, memory, and other hardware and software for processing the commands from the PED and sending appropriate signals to the appropriate seat devices. In responding to the command by the PED 18, the control unit is configured to comply with one or more regulations for ensuring safety of the passengers on the aircraft.

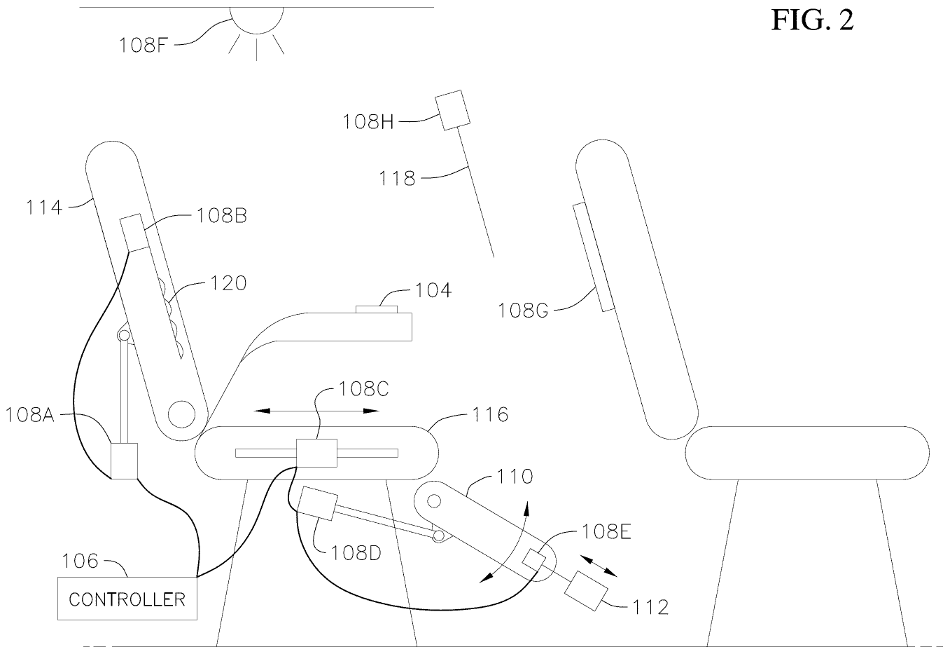

FIG. 2 is a schematic block diagram of the seat 10a of FIG. 1 according to an exemplary embodiment. In a typical situation, a passenger (not shown) sitting in the seat 10a uses a keypad 104, buttons/switches on or near the chair, and/or buttons provided in an in-flight entertainment (IFE) system 108G, to adjust the seat position and associated devices. The keypad 104 and IFE system 108G communicate with a seat controller 106 which, in turn, controls one or more actuators 108A-108H. The seat controller 106 may be similar, for example, to the control unit 12 of FIG. 1.

In one embodiment, the seat controller 106 drives the actuators which control various aspects of the seat. For example, an actuator 108D moves leg rest 110 that moves from a substantially vertical retracted position to a substantially horizontal, extended position. An actuator 108E moves a foot rest 112, that moves from a substantially extended to a substantially retracted position. An actuator 108A moves the reclining back rest 114 that moves from a substantially vertical position to a substantially horizontal position. An actuator 108C moves the seat pan 116. An actuator 108H moves the privacy screen 118. A lumbar controller 108B drives/controls the lumbar bladder 120. In addition, each actuator may include one or more position determining components such as a transducer or sensor (not shown).

A variety of devices associated with a seat may also be controlled by the passenger. For example, by using a keypad 104, IFE system 108G, and/or PED 18 (FIG. 1), the passenger may control cabin lighting 108F, audio systems (not shown), seat warmers (not shown), air vents (not shown), and/or other devices. In one embodiment, the processing of commands for controlling the seat devices is performed in the controller 106. In this regard, the controller 106 generates control signals for each actuator and other devices, and sends these signals to each actuator/device via separate connection leads. In addition, any signals from sensors in the actuators are sent back to the controller.

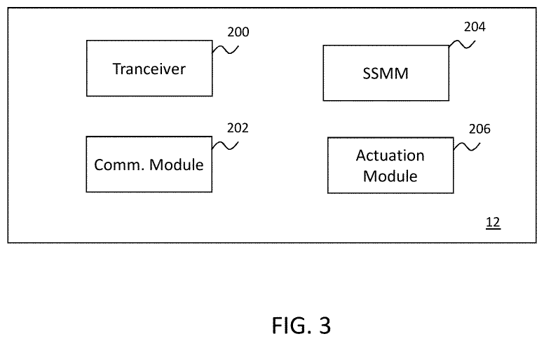

FIG. 3 is a more detailed block diagram of the control unit 12 according to one exemplary embodiment. The control unit 12 may include a transceiver 200 for transmitting and receiving wireless communication signals to and from the PEDs 18. The wireless communication signals may be, for example, short range radio waves adhering to a communication protocol, such as, Bluetooth LE.

In one embodiment, the control unit 12 includes various modules for processing commands from the PEDs 18 to control the passenger seats. The modules include, but are not limited to, a communication module 202, signal strength monitoring module 204, and actuation module 206, The modules may be implemented via software, firmware (e.g. via an ASIC), or in any combination of software, firmware, and/or hardware. Furthermore, the functionality of the various modules may be combined into a single module, or further subdivided into one or more sub-modules.

In one embodiment, the communication module 202 is configured to establish communication with a PED 18 of a passenger who has been assigned to a particular seat of an aircraft. In this regard, the communication module 202 includes an appropriate protocol stack (e.g. Bluetooth protocol stack) and other standard logic for establishing a wireless connection with the appropriate PED, and for communicating with the PED over a wireless personal area network that is established in response to the wireless connection. In one embodiment, the PED 18 is configured to establish a connection with the communication module 202 that controls the seat to which the passenger associated with the PED, has been assigned.

In one embodiment, in order to comply with certain certification requirements, control of a passenger's seat via the PED 18 is allowed only when the passenger associated with the PED with which communication has been established (hereinafter “connected PED”), is deemed to be within a visible range of the seat. The estimation of the distance of the passenger to his seat may be based, for example, on the strength of the signal transmitted by the connected PED. Signal strength may be measured via a received signal indicator (RSSI) as understood by those of skill in the art. As the passenger holding the PED 18 moves away from his seat, he is further away from the control unit 12, and hence, the RSSI reading becomes weaker. As the passenger approaches his seat, he is closer to the control unit 12, and hence, the RSSI reading becomes stronger. In one embodiment, the communication module 202 is configured to periodically receive heartbeat (also referred to as status or “keep-alive”) messages from the connected PED 18. The signal strength monitoring module 204 analyzes the messages and determines (e.g. via a standard RSSI algorithm) strength of the signal to decide whether the signal strength is at least of a threshold value. If so, the passenger is deemed to be within a valid range/visible range of the seat allowed to control the seat/suite.

In one embodiment, the control unit 12 includes one or more antennas 208 coupled to a housing of the control unit 12. When used, the antennas improve the utility of the RSSI algorithm that is invoked for deducing whether the passenger is within a valid range of his seat. In one embodiment, the antenna is a standard isotropic antenna where the signal strength is equal in all directions (omnidirectional).

The antenna may also take the form of a directional antenna. A directional antenna may allow increase of signal gain within the suite area while significantly reducing gain outside of the suite area. For example, a directional antenna may be positioned so that signal is strong when the passenger is in front of the antenna (e.g. when the passenger is in his seat), and significantly weak when the passenger steps outside of the seat. Utilizing a higher gain directional antenna also allows the power to be reduced, therefore reducing the overall electrical noise in the aircraft cabin.

In some embodiments, instead of a single directional antenna, a phased array is used for beam forming to determine an angle of the signals that are received by the control unit 12. By estimating the angle in which the signals are received, the RSSI algorithm may be enhanced for greater location accuracy of the passenger (e.g. within the centimeter range).

In one embodiment, the actuation module 206 also included in the control unit 12 is configured to receive and process commands from the connected PED 18 over the wireless personal area network. In one embodiment, the commands are processed in response to the signal strength processing module 204 concluding that the PED is within a valid range to the seat. The commands from the PED 18 may be for controlling the actual seat as well as other suite components/environment surrounding the seat. The actuation module 206 may also generate messages for transmitting to the PED 18 over the wireless personal area network. The messages may cause output of audio/visual cues by the PED, including, for example, illumination or graying out of one or more control icons depending on the distance of the connected PED to the seat.

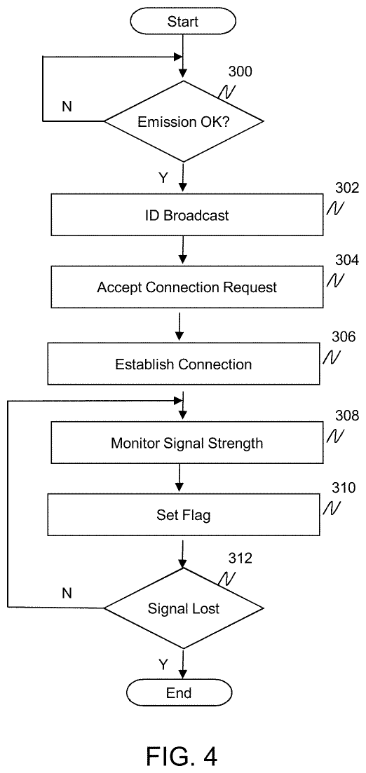

FIG. 4 is a flow diagram of a process for establishing a wireless personal area network connection between the control unit 12 and a particular PED 18 according to an exemplary embodiment. In act 300, a determination is made as to whether wireless signals are allowed to be emitted within the cabin of an aircraft boarded by the passenger carrying the PED 18. Depending on the jurisdiction and/or airline involved, there may be different rules regarding RF emissions. In one embodiment, the system controller 16 (FIG. 1) monitors current conditions of the aircraft and determines whether a trigger condition has been satisfied to enable or disable RF emissions. In this regard, the system controller 16 may be configured with an emission control rule. An example emission control rule may state that Bluetooth emissions are prohibited after take-off until the aircraft has reached an altitude of 10,000 feet. Given such a rule, the system controller 16 transmits a signal to the various control units 12 onboard the aircraft for disabling RF transmission/reception capabilities of the control units upon the system controller 16 detecting take-off of the aircraft. The system controller 16 monitors the altitude of the aircraft for determining whether the altitude has reached 10,000 feet. Upon reaching this altitude, the system controller 16 transmits a signal to the control units 12 for enabling RF communication capabilities. In a similar fashion, the system controller 16 transmits a signal to the control units 12 for disabling RF communication capabilities when the aircraft prepares for landing. The RF communication capabilities may be enabled again via an express signal from the system controller 16 after the aircraft has landed.

With reference again to act 300, if it has been determined that wireless signals are allowed within the cabin, the control unit 12 broadcasts an RF signal containing the seat ID of the seat that it is configured to control. For ease of description, it is assumed that the control unit 12 transmits a single seat ID for a single seat it controls. However, as discussed above, the control unit 12 may, in some situations, be configured to control more than one seat (e.g. up to four seats), in which case the broadcast includes the seat IDs of all the seats it controls.

In one embodiment, the broadcast signal from the control unit 12 is just strong enough to be received by the PEDs 18 as they are in the vicinity (e.g. 5 feet or less) of the seat controlled by the control unit 12. In some embodiments, the control unit 12 is programmed, during its setup, with the seat ID of the seat it is to control. The seat ID information may also be provided to the control unit 12 by the system controller 16 or IFE system 108G (e.g. during initialization), and/or otherwise embedded into the control unit 12.

In act 304, the control unit 12 receives and accepts a connection request from the PED 18 associated with the passenger that is assigned to the seat that is controlled by the control unit. The PED 18 transmits the request in response to receiving the broadcast from the control unit 12, and determining that the seat ID in the broadcast is for the seat that has been assigned to the passenger by the airline. In one embodiment, information on the seat that has been assigned to the passenger (e.g. seat 14A) is stored in the application 20 hosted by the PED 18. The application 20 compares the received seat ID in the broadcast (e.g. “14A” or some other identifier correlated to “14A”, such as, for example, a cryptographic hash of an identifier derived from the LOPA “14A”), to what is saved in the application, for a match. Upon finding the match, a wireless personal area network connection is established, in act 306, between the control unit 12 and the PED 18. The wireless personal area network connection may be, for example, a Bluetooth connection.

The establishing of the personal wireless area connection between the control unit 12 and the PED 18 based on the specific seat that has been assigned to the passenger helps to comply with safety regulations that state that only the occupant of the seat may control the seat.

After establishing the connection, the control unit 12 continues to monitor the signal strength of the emissions by the connected PED 18. In this regard, the control unit receives status messages from the connected PED on a periodic basis (e.g. every 1 sec). The received signal is processed by the signal strength monitoring module 204 via, for example, the RSSI algorithm, to compute an RSSI value (signal strength value). In one embodiment, the RSSI algorithm measures the strength of the received signal to approximate the distance to the transmitting PED. If the control unit is equipped with multiple antennas arranged in an array (e.g. antenna 208), AoA estimation may also be conducted to better estimate the location of the transmitting PED.

In one embodiment, the signal strength monitoring module 204 compares the computed distance of the PED device to the control unit 12, against a threshold distance that is preset in the memory of the control unit, to determine a state of a flag that is maintained by the module 204. In act 310 the flag is set to the appropriate state based on the comparison. For example, the flag may be set to a value of 1 to indicate that the PED device is within a valid distance (e.g. within 5 feet), and to a value of 0 to indicate that the PED device is outside the valid distance (e.g. beyond 5 feet).

In other embodiments, instead of computing an estimated distance to a threshold distance, the signal strength value may be compared against a threshold signal strength value to determine the state of the flag. In one embodiment, the signal strength value is an RSSI value (which may vary from vendor to vendor of the Bluetooth Radio hardware) that is computed by the signal strength monitoring module 204. The signal strength monitoring module 204 may be configured to calibrate the relative RSSI value to an absolute signal strength (e.g. in dBm). In one example, a signal strength of −30 to −50 dBm may be deemed to be sufficient to set the flag value to 1.

In one embodiment, the monitoring of the signal strength and setting of the flag continues until there is a loss of signal with the PED as determined in act 312.

The threshold distance or signal strength value that is preset in the memory of the control unit 12 may vary from control unit to control unit, and/or from seat to seat depending on the location of the seat and its surrounding. For example, a seat that has high walls near the seat may have a threshold value that is lower than a seat that is not near any walls. In this regard, the threshold value may correspond to the maximum distance that the passenger may be from his seat device while still being in line of sight to the seat. Such distance may be, for example 5 feet.

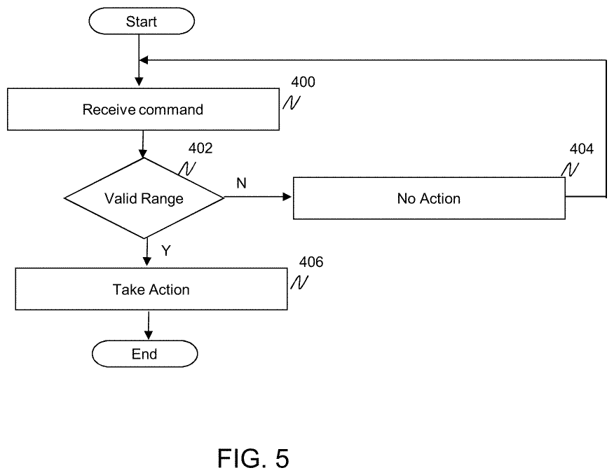

FIG. 5 is a flow diagram of a process for controlling a seat device based on commands from the PED 18 according to an exemplary embodiment. In act 400, the transceiver 200 of the control unit 12 receives a command from the PED 18 to which a connection has been made per the process described with respect to FIG. 4. The command includes, for example, data relating to the icons, buttons, and/or keys pressed on the PED for controlling the seat device. For example, the command may be to recline the passenger's seat or to control a light source associated with the seat. In one embodiment, the command is encrypted so as to prevent hacking by an unauthorized entity. The encryption may be, for example, based on the Bluetooth protocol or via any encryption algorithm known in the art.

In act 402, a determination is made as to whether the passenger is within a valid range of the seat. In this regard, the actuation module 206 checks the status of the flag in memory to determine whether it has been set or not.

If the flag is not set (e.g. has a value of 0), the passenger is deemed to be outside of the line of sight to his seat or seat device, and the command from the PED is ignored and no action is taken in act 404. Thus, the passenger is not allowed to control the seat device via the PED. That is, although the signal strength of the emissions by the PED is sufficient for all intent and purposes to successfully transmit the seat control command to the control unit, because of safety regulations relating to seat control, the passenger is nonetheless prohibited from controlling the seat device. In one embodiment, the prohibition applies to only the seat as safety is often related to seat motion. In some embodiments, other peripheral devices may be prohibited or enabled based on airline or seat maker preferences.

If, however, the flag is set (e.g. has a value of 1), the passenger is deemed to be within the line of sight to his seat or seat device, and the command from the PED is processed by the actuation module 206 to take the action corresponding to the command in act 406. In this regard, the actuation module 206 transmits a signal to a corresponding one of the actuators 108A-108H to actuate the seat device per the processed command.

According to some embodiments, control of the seat devices using the PED 18 complies with entrapment rules to ensure safety of passengers. An example entrapment rule may be that in all entrapment areas and under all load conditions, the entrapment force does not exceed 25 lbf. In this regard, actuators in the entrapment areas where a passenger may be pinched or trapped, detect the amount of force being exerted in those areas. According to one embodiment, the control unit 12 is configured to ignore any command from the PED 18 that may violate an entrapment rule. Thus, for example, in response to the passenger selecting a command on the application 20 to recline his seat, the control unit 12 transmits signals to the appropriate actuators to effectuate the reclining. If an entrapment situation is detected, the reclining may continue until the maximum allowed entrapment force is reached. In one embodiment, no safety mitigations that may override the rule are allowed.

In some embodiments, in order to ensure further safety of the seats, a TTL (taxi-takeoff-landing) override button may be provided which, when actuated, overrides all commands from the PED 18 (or disables wireless communication with the control unit 12) and forces the seat to a position suitable for TTL. The TTL override button may be incorporated, for example, into the passenger control device (e.g. a keypad).

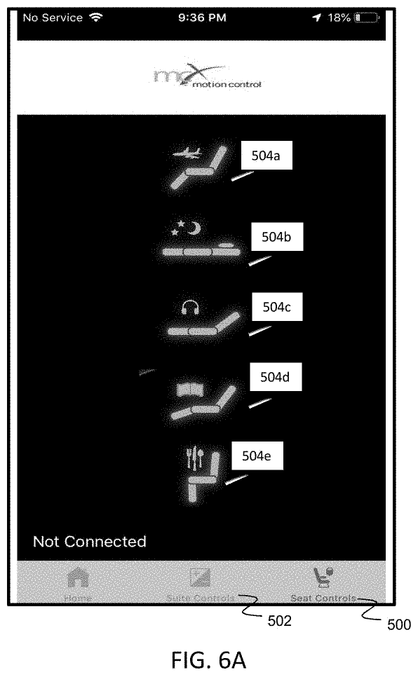

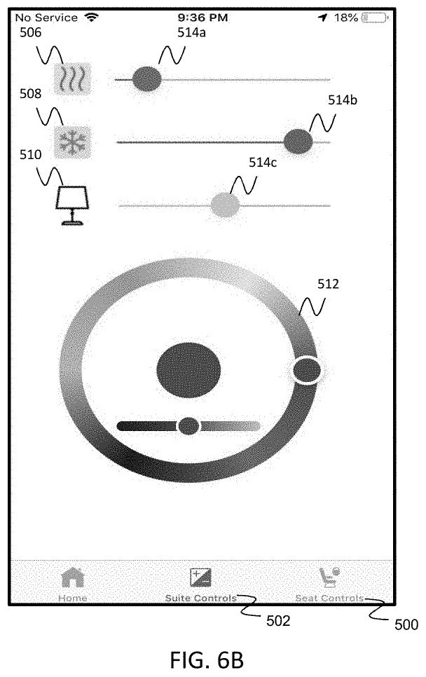

FIGS. 6A-6B are screen shots of a graphical user interface (GUI) provided by the application 20 hosted in the PED 18 for controlling the seat devices according to an exemplary embodiment. The GUI provides a seat control icon 500, which, upon selection, causes display of various options for controlling the seat, and a suite control icon 502, which, upon selection, causes display of various options for suite control. As shown in FIG. 6A, various seat control icons 504a-504e are displayed upon selection of the seat control icon 500. Selection of a particular one of the icons 504a-504b causes the seat to move to the position that is depicted by the icon.

As shown in FIG. 6B, various suite control icons 506-512 are displayed for controlling the suite and surrounding environment upon selection of the suite control icon 502. For example, the passenger may manipulate a control bar 514a associated with a seat warmer icon 506 to control the passenger's seat warmer. The passenger may manipulate a control bar 514b associated with an air vent icon 508 to control the passenger's air vent. The passenger may manipulate a control bar 514c associated with a light icon 510 to control the passenger's light. In addition, the passenger may manipulate an icon 512 to change the color of the lights in the furniture surrounding the seat.

In one embodiment, one or more of the displayed icons may be grayed out in response to signals from the control unit 12. The signal may be transmitted in response to the control unit 12 determining that the passenger is not within a valid range to his seat. In one embodiment, a grayed out icon becomes disabled to perform the functions of the icon. In addition or in lieu of graying out the icon, the control unit 12 may transmit messages that are displayed by the GUI to indicate that one or more control options are unavailable. Other messages may also be displayed by the GUI, such as, for example, messages indicating that a wireless connection has been established with the control unit, and/or availability or unavailability of seat control via the PED.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

As used herein, the terms “use”, “using”, and “used” may be considered synonymous with the terms “utilize”, “utilizing”, and “utilized”, respectively.

While this invention has been described in detail with particular references to illustrative embodiments thereof, the embodiments described herein are not intended to be exhaustive or to limit the scope of the invention to the exact forms disclosed. For example, although the various embodiments are described in the context of aircraft seat and suite control, the embodiments may extend to types of seat and suite control, such as, for example, seat and suite control in automobiles, trains, or moving vehicles as will be appreciated by a person of skill in the art. Persons skilled in the art and technology to which this invention pertains will thus appreciate that alterations and changes in the described structures and methods of assembly and operation can be practiced without meaningfully departing from the principles, spirit, and scope of this invention, as set forth in the following claims and equivalents thereof.

What is claimed is:

1. A method for controlling a seat device, the method comprising:
broadcasting, by a control unit, an identifier associated with a seat assigned to a passenger;
establishing, by the control unit, a personal wireless area network connection with a personal electronic device (PED) associated with the passenger, the connection being established in response to the PED receiving the identifier and determining that the identifier is for the seat assigned to the passenger;
monitoring, by the control unit, strength of a signal received from the PED over the wireless personal area network;
setting, by the control unit, a flag based on the strength of the signal;
receiving, by the control unit, over the wireless personal area network, a command from the PED to control the seat device;
determining, by the control unit, state of the flag in response to the command;
transmitting, by the control unit, a signal to take an action invoked by the command in response to the flag being in a first state; and
refraining, by the control unit, from transmitting the signal to take the action invoked by the command in response to the flag being in a second state.

2. The method of claim 1, wherein the control unit is configured to control seat devices associated with a plurality of seats, wherein the plurality of seats include the seat assigned to the passenger, the control unit transmitting a unique identifier for each of the plurality of seats.

3. The method of claim 1, wherein the identifier is associated with a seat identifier.

4. The method of claim 1, wherein the PED further hosts an application storing information on the seat assigned to the passenger, wherein the application compares the received identifier with the information on the seat assigned to the passenger.

5. The method of claim 1, wherein the personal wireless area connection is a Bluetooth low energy connection.

6. The method of claim 1 further comprising:
monitoring a criteria by a system controller coupled to the control unit;
transmitting, by the system controller, a signal for enabling the communication over the wireless personal area network in response to detecting a first criteria; and
transmitting, by the system controller, a signal for disabling the communication over the wireless personal area network in response to detecting a second criteria.

7. The method of claim 1, wherein the command from the PED is an encrypted command that is decrypted by the control unit prior to taking the action invoked by the command.

8. The method of claim 1, wherein the setting of the flag includes:
setting the flag to the first state in response to the strength of the signal being above a threshold value; and
setting the flag to the second state in response to the strength of the signal being below the threshold value.

9. The method of claim 8, wherein the first state is indicative of the passenger being in a line of sight to the seat assigned to the passenger, and the second state is indicative of the passenger being out of the line of sight to the seat.

10. The method of claim 1, further comprising:
monitoring, by the control unit, an entrapment condition; and
transmitting, by the control unit, a signal to stop the action invoked by the command in response to determining the entrapment condition.

11. The method of claim 1, wherein the seat device is a component of the seat or a component of a suite surrounding the seat.

12. The method of claim 1 further comprising:
transmitting, by the control unit, in response to the flag being in the second state, a message to the PED for indicating that the command is unavailable.

13. A system for controlling a seat device comprising:
a processor; and
a memory, wherein the memory includes instructions that, when executed by the processor, cause the processor to:
broadcast an identifier associated with a seat assigned to a passenger;
establish a personal wireless area connection with a personal electronic device (PED) associated with the passenger, the connection being established over the personal area network in response to the PED receiving the identifier and determining that the identifier is for the seat assigned to the passenger;
monitor strength of a signal received from the PED over the wireless personal area network;
set a flag based on the strength of the signal;
receive over the wireless personal area network, a command from the PED to control the seat device;
determine state of the flag in response to the command;
transmit a signal to take an action invoked by the command in response to the flag being in a first state; and
refrain from transmitting the signal to take the action invoked by the command in response to the flag being in a second state.

14. The system of claim 10, wherein the instructions further cause the processor to control a plurality of seats, wherein the plurality of seats include the seat assigned to the passenger, the instructions further including instructions that cause the processor to transmit a unique identifier for each of the plurality of seats.

15. The system of claim 10, wherein the identifier is associated with a seat identifier.

16. The system of claim 10, wherein the PED hosts an application configured to store information on the seat assigned to the passenger, wherein the application is further configured to compare the received identifier with the information on the seat assigned to the passenger.

17. The system of claim 10, wherein the personal wireless area connection is a Bluetooth low energy connection.

18. The system of claim 10 further comprising a controller configured to:
monitor a criteria for enabling communication over the wireless personal area network; and
transmit a signal to the processor for enabling the communication over the wireless personal area network.

19. The system of claim 10, wherein the command from the PED is an encrypted command that is configured to be decrypted by the processor prior to taking the action invoked by the command.

20. The system of claim 10, wherein the instructions that cause the processor to set the flag include instructions that cause the processor to:
set the flag to the first state in response to the strength of the signal being above a threshold value; and
set the flag to the second state in response to the strength of the signal being below the threshold value.

21. The system of claim 20, wherein the first state is indicative of the passenger being in a line of sight to the seat assigned to the passenger, and the second state is indicative of the passenger being out of the line of sight to the seat.

22. The system of claim 10, wherein the instructions further cause the processor to:
monitor an entrapment condition; and
transmit a signal to stop the action invoked by the command in response to determining the entrapment condition.

23. The system of claim 10, wherein the seat device is a component of the seat or a component of a suite surrounding the seat, and the command is for controlling the seat device.

24. The system of claim 10, wherein the instructions further cause the processor to transmit, in response to the flag being in the second state, a message to the PED for indicating that the command is unavailable.
